(19) United States
(12) Patent Application Publication
(10) Pub. No.: US 2009/0080317 A1
(43) Pub. Date: Mar. 26, 2009

(54) DEVICES FOR STORING AND READING DATA ON A HOLOGRAPHIC STORAGE MEDIUM

(75) Inventor: Christophe Martinez, Grenoble (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Commissariat A L'Energie Atomique

(21) Appl. No.: 12/236,861

(22) Filed: Sep. 24, 2008

(30) Foreign Application Priority Data
Sep. 24, 2007 (FR) 07/06673

(51) Int. Cl. G11B 7/00

(52) U.S. Cl. 369/103; G9B/7

(57) ABSTRACT

In one embodiment, the invention provides a device for storing data on a holographic storage medium, comprising means for generating an object beam encoded by spatial modulation with the data to be stored, and means for generating a reference beam spatially modulated according to predetermined configurations to produce a multiplexing of the data, comprising an optical storage medium on which is implemented a succession of diffractive optical elements, each introducing a distinct modulation configuration of the reference beam. The invention further provides a device for reading the duly-stored data, using an optical storage medium of the same type for generating and spatially modulating a read beam, and a device for replicating a first holographic storage medium on a second holographic medium, comprising such a reading device coupled to such a storage device.

### CROSS REFERENCE TO RELATED APPLICATIONS

This application claims priority from French patent application 07/06673, filed Sep. 24, 2007.

### FIELD OF THE INVENTION

The invention relates to a device for storing data on a holographic storage medium and to a device for reading said data. The invention also relates to a device for copying a holographic data storage medium.

### BACKGROUND OF THE INVENTION

Holographic memories are seriously considered to potentially form the next generation of mass storage media. In practice, they present considerable advantages:
Firstly, a very high storage density, because the storage of the data is done in volume, and not only on a surface as is the case with conventional optical disc storage media (CD, DVD, HD-DVD and BluRay). Furthermore, multiplexing techniques make it possible to store in one and the same holographic volume a plurality of data blocks and address them individually. Thus, it is considered that holographic-type optical discs could, in the near future, achieve capacities exceeding 1000 Gb (gigabytes), compared to 50 Gb for the dual-layer BluRay discs.
Then, a very high data reading speed. In practice, in the case of the conventional optical storage media, the data is read bit by bit by the movement of a light spot over the surface of the disc. In the case of a holographic memory, the volume reading generates a succession of wavefronts which encode blocks or “pages” of data, which can be acquired simultaneously. The predicted reading rates are of the order of 1000 Mbit/s (megabits per second), compared to 72 Mbit/s for the BluRay format.

A general overview of the holographic data storage technology can be found on the sites of the main manufacturers in the field (www.aprilisinc.com and www.inphase-technologies.com) . . . .

As a general rule, to produce a hologram, two light beams that are mutually coherent (deriving from the same laser source), called object beam and reference beam, are superimposed within a photosensitive material. As the beams overlap, an interference figure or pattern is created and stored in the photosensitive volume. To read the hologram, it is necessary to illuminate it with a read beam identical to the reference beam (or its conjugate complex). The diffraction of this read beam by the hologram generates a replica of the object beam.

The theory of holography is explained in chapter 8 of the book by J. W. Goodman, “Introduction to Fourier Optics”, 1st edition, McGraw-Hill Book Company.

To store the information in a hologram, it is sufficient to code said information in the form of a spatial modulation (of phase and/or amplitude modulation) of the object beam, then use a reference beam whose properties are known. It will be understood that the reconstruction of the object beam makes it possible to simultaneously read all the coded data.

The spatial modulation of the object beam can be produced, in a manner known per se, by a spatial light modulator (SLM) with liquid crystals (references to SLMs of this type can be found on the manufacturer DisplayTech's website: www.displaytech.com) or with micro-mirrors (for example, the DLP micro-mirror matrix developed by Texas Instruments: www.dlp.com).

A large storage density is obtained thanks to multi-plexing techniques. In practice, it is possible to superimpose, in one and the same photosensitive volume, a plurality of distinct holograms, stored from different object and reference beams. When said photosensitive volume is illuminated by a read beam identical to one of the reference beams used to store the holograms, only the corresponding object beam is reproduced (affected by a background noise caused by the other holograms). It is this property that enables the holographic memories to achieve such high storage densities.

Several holographic multiplexing techniques are known from the prior art. Of particular note are phase coding and angle coding.

The phase-coding technique is described, for example, by the article by S. Yasuda et al. “Coaxial holographic data storage without recording the dc components”, Opt. Lett. 2006 31 (17) pp 2607-2609, or even by the reference: Z Karpati et al. “Comparison of coaxial holographic storage arrangements from the M number consumption point of view”, Jpn. J. Appl Phys 46 (2007) 3845-3849. It consists in using reference beams (and therefore read beams) spatially modulated in phase according to modulation configurations that are substantially orthogonal to each other.

The orthogonality of the phase coding makes it possible to avoid the read cross talk between the hologram coded by a reference beam and the diffraction of the read beam corresponding to this same reference beam by the other holograms. If [φ₁^{m}, φ₂^{m}, φ₃^{m}, . . . φₙ^{m}] is used to denote the phase components of the reference beam m (φ=0 or π), then the orthogonality condition can be expressed by the following relation described by C. Denz et al. “Potentialities and limitations of hologram multiplexing by using the phase-encoding technique” Appl. Opt. 31 (1992) pp. 5700-5705:

$${\sum }_{n} exp [ j ( {ϕ}_{n}^{p} - {ϕ}_{n}^{m} ) ] = \vert \begin{matrix}0 & if p \neq m \\ 1 & if p = m\end{matrix}$$

This relation expresses the fact that two reference beams interfere destructively if they are different.

The spatial modulation of the reference and read beams is obtained thanks to spatial light modulators (SLM) with liquid crystals or micro-mirrors. These devices are costly, and while their presence can be tolerable in a data writing system (which, at least initially, can remain a professional or semi-professional item of equipment), it is far less so in the reading systems intended for the general public. Furthermore, the low operating frequency of the SLMs (a few hundreds of Hertz) strongly limits the data writing and reading speed.

The angle coding technique is known, for example, from U.S. Pat. No. 6,700,686. It consists in using reference beams (and therefore read beams) which are incident to the photosensitive material according to different angles. To do this, a data storage and/or reading device can use an optical system comprising a pivoting mirror, an acousto-optical modulator and a lens that moves translation-wise. In all cases, the result is relatively complex—and therefore costly—and slow systems. For example, if a pivoting mirror is used to determine the direction of the reference/read beam, its movement must be controlled finely.

It will be noted that angle multiplexing can be considered as a particular case of phase multiplexing, in which all the modulation configurations introduce a distinct linear phase shift of the light beam.

The other multiplexing and demultiplexing techniques present similar drawbacks: they require relatively complex and costly equipment, and do not make it possible to optimally exploit the potential of holographic storage regarding reading speed.

Furthermore, the replication of the “holographic discs” is slow and costly. In practice, the pressing or moulding techniques that have allowed for the emergence of the various generations of optical discs do not apply to holographic memories, because the data is stored in volume and no longer on a surface. Now, the depth of the media is not accessible on pressing.

All these drawbacks have greatly slowed down the commercial penetration of holographic data storage.

### SUMMARY OF THE INVENTION

One aim of the invention is to resolve at least some of the problems posed by the prior art.

To achieve this aim, the invention relies on the coding of the reference and/or read beam by an optical storage medium-type object, presenting a structuring arrangement producing a succession of diffractive optical elements, each of said elements introducing a distinct modulation configuration of said beam. The movement of this object thus makes it possible, by scanning the diffractive optical elements, a sequential and repeatable modification of the wavefront of the reference or read beam. Preferably, the object is a disc that can be rotated in the path of the reference beam. The replication techniques commonly used in the optical storage field can be employed in order to allow a low-cost and mass-production fabrication of this object.

The use, for the multiplexing and the demultiplexing, of such an object—hereinafter called “coding disc”—makes it possible to produce devices for writing and reading data on holographic media that have a simple structure, present a reduced cost and can nevertheless operate at a very high speed (data rate). The combined use of a reading device and a writing device according to the invention makes it possible to replicate “holographic discs” in economically viable conditions.

More specifically, an object of the invention is a device for storing data on a holographic storage medium, comprising a plurality of data storage areas, said device comprising:
means for generating a first light beam called reference beam, and a second light beam called object beam, said beams being mutually coherent;
means for spatially modulating said object beam, the introduced modulation being representative of a block of data to be stored;
means for spatially modulating, in a predetermined way, said reference beam;
comprising an optical storage medium on which is implemented a succession of diffractive optical elements, each introducing a distinct modulation configuration and a first actuator for displacing said optical storage medium in order to sequentially bring said diffractive optical elements over the path of the reference beam;
an optical system for superimposing the spatially modulated object and reference beams, on a data storage area of said holographic storage medium, to store thereon the resulting interference figure;
a second actuator, synchronized with said means for spatially modulating the object and reference beams, to sequentially bring said data storage areas to the region where said beams are superimposed and interfere;

said means for spatially modulating said object and reference beams being synchronized to store a plurality of data blocks on said data storage area, each block being associated with a distinct modulation configuration of the reference beam, so as to multiplex said data blocks;

wherein said holographic storage medium is a disc that can be actuated rotationally about an axis and perpendicularly translationally about said axis, said data storage areas being arranged in a plurality of circular concentric or spiral tracks, the centre of which coincides with said axis.

In particular, said optical storage medium may be a disc suitable to be actuated rotationally about an axis and comprising a plurality of concentric circular tracks, the centre of which coincides with said axis, each of said tracks containing one and the same succession of diffractive optical elements, the device also comprising:
means for generating and spatially modulating a plurality of object beams;
means for generating an equal number of reference beams, each of said reference beams being directed so as to cross one of the tracks of the optical storage medium to be in turn spatially modulated; and
a plurality of optical systems for superimposing each object beam on a reference beam on a data storage area belonging to a different track of said holographic storage medium, to store thereon the resulting interference figure;
so as to perform said data storage in parallel on several tracks of the holographic storage medium.

Another object of the invention is a device for reading data recorded on a holographic storage medium, comprising a plurality of data storage areas, said device comprising:
means for generating a coherent light beam, called read beam;
means for spatially modulating, in a predetermined way, said read beam;
an optical system for directing the spatially modulated read beam to a data storage area of said holographic storage medium, and for collecting the light diffracted by said area; and
a second actuator, synchronized with said means for spatially modulating the read beam, to sequentially bring said areas over the path of said beam;

said means for spatially modulating said read beam being adapted to read a plurality of data blocks stored on said data storage area, each block being read using a distinct modulation configuration of the read beam, so as to demultiplex said data blocks;

in which said means of spatially modulating said read beam comprises an optical storage medium on which is implemented a succession of diffractive optical elements, each introducing one said distinct modulation configuration, and a first actuator for displacing said optical storage medium in order to sequentially bring said diffractive optical elements over the path of the read beam;

wherein said holographic storage medium is a disc that can be actuated rotationally about an axis and translationally perpendicularly to said axis, said data storage areas being arranged in a plurality of circular concentric or spiral tracks, the centre of which coincides with said axis.

Again, said optical storage medium may be a disc suitable to be actuated rotationally about an axis and comprising a plurality of concentric circular tracks, the centre of which coincides with said axis, each of said tracks containing one and the same succession of diffractive optical elements, the device also comprising:
means for generating a plurality of read beams, each of them being directed so as to cross one of the tracks of the optical storage medium to be spatially modulated; and
a plurality of optical systems, for directing each spatially modulated read beam to a data storage area belonging to a different track of said holographic storage medium, and for collecting the light diffracted by each area, so as to perform said data read in parallel on several tracks of the holographic storage medium.

A further object of the invention is a device for replicating a first holographic storage medium on a second holographic medium, said replication device comprising a device for storing data on said second holographic medium, as described above, in which the means of generating and spatially modulating the object beam or beams comprise a device for reading said first holographic storage medium as described above.

### BRIEF DESCRIPTION OF THE DRAWINGS

Other characteristics, details and advantages of the invention will become apparent from reading the description, given with reference to the appended drawings given by way of example and which represent, respectively:

FIGS. 1a and 1b: the principle of storing and reading a hologram.

FIG. 2: a principle of the prior art for the angular multiplexing of holograms.

FIG. 3: a principle of the prior art for the phase multiplexing of holograms.

FIG. 4: a principle of the invention for the angular multiplexing of holograms.

FIG. 5: a principle of the invention for the phase multiplexing of holograms.

FIGS. 6a and 6b: exemplary embodiments of a device for storing data on a holographic storage medium based on angular multiplexing, in co-propagative and contra-propagative storage configuration respectively.

FIGS. 7a and 7b: exemplary embodiments of a device for reading data recorded on a holographic storage medium based on angular multiplexing, in co-propagative and contra-propagative data reading configuration respectively.

FIGS. 8a and 8b: exemplary embodiments of a device for replicating a holographic medium obtained by angular multiplexing according to the invention: data written by co-propagative method and read by co-propagative method in FIG. 8a; data written in contra-propagative method and read in co-propagative method in FIG. 8b.

FIG. 9: an exemplary embodiment of a device for storing data on a holographic storage medium based on phase multiplexing.

FIG. 10: an exemplary embodiment of a device for reading data recorded on a holographic storage medium based on phase multiplexing.

FIGS. 11a and 11b: exemplary embodiments of a device for replicating a holographic medium obtained by phase multiplexing according to the invention; in FIG. 11a, simple replication; in FIG. 11b, parallel replication.

FIG. 12: an example of synchronization arrangement for writing/reading/replicating holographic discs according to the invention.

FIG. 13: an embodiment of a coding disc for the reference/read beam according to the invention.

FIGS. 14a-14e: steps of a method of fabricating coding discs for the reference beam by mastering and moulding replication.

FIG. 15: an example of a series of grating-type diffractive optical elements on the coding disc for angle multiplexing.

FIG. 16: an example of a succession of diffractive optical elements on the coding disc for phase multi-plexing.

FIG. 16b: an example of a diffractive optical element on the coding disc for phase multiplexing, according to a variant of the invention.

FIGS. 17a-17c: fabrication steps for a coding disc by mastering and replication by modifying the surface roughness. And

FIG. 18: an example of an optical element segmented in sections of variable orientation.

### DETAILED DESCRIPTION

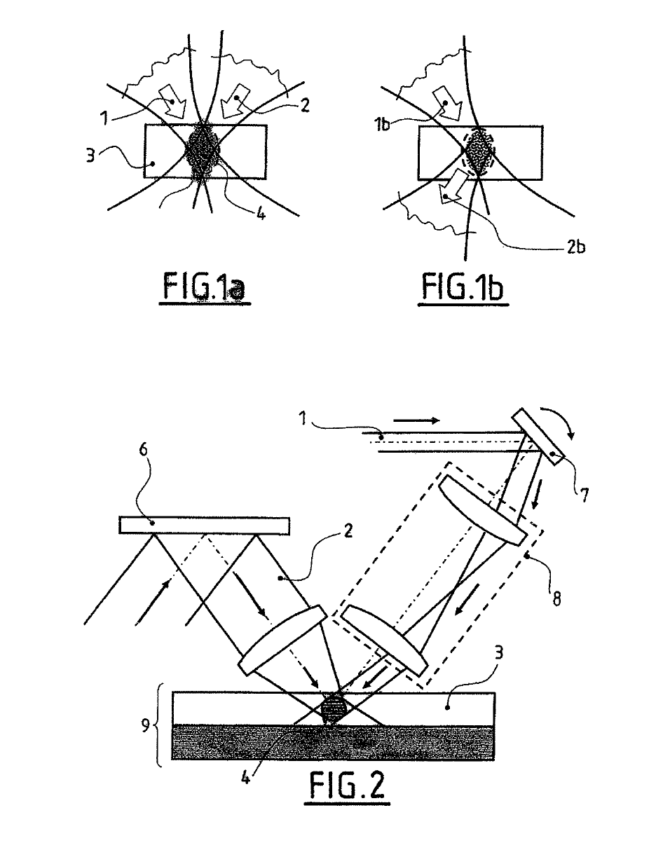

FIGS. 1a and 1b illustrate the general principle of the writing and reading of a hologram, which has already been described above. Two beams are super-imposed within a photosensitive material 3. The first, denoted 1, is called reference beam; the second, denoted 2, object beam. Each beam is characterized by a field being propagated in space. Where the beams overlap, a complex system of interferences is created. These interferences are stored in a volume of the holographic medium 3 to form the hologram 4.

For reading, this hologram is illuminated by a reference read beam 1b, the propagative field of which is identical to that of the storage beam 1 (or its conjugate complex, but this second case will be disregarded hereinafter). In this case, the hologram diffracts the reference beam so as to form a new beam 2b, the propagative field of which is, as a first approximation, identical to that of the object beam 2.

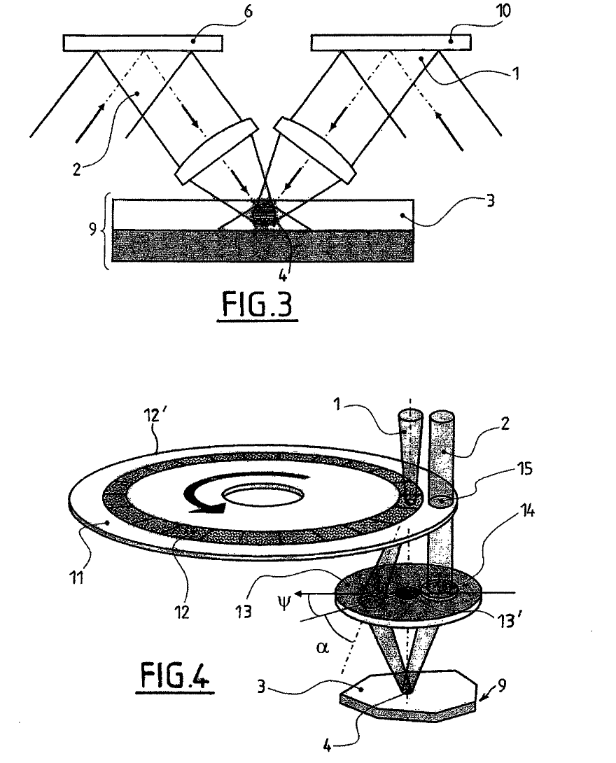

FIG. 2 describes the principle used in the prior art to perform angle multiplexing of the reference beam, a principle that has also been discussed hereinabove. A laser beam is split into two sub-beams 1 and 2. The object beam 2 is incident to a spatial light modulator 6 (SLM) which encodes its wavefront according to the data to be stored. This SLM can comprise a matrix of micro-mirrors of the type marketed by Texas Instruments (DLP Technology). Each micro-mirror reflects or does not reflect a part of the wavefront making it possible to code thereon the values 0 or 1 of the data to be stored. This object beam is generally focussed using an optic in the holographic medium 9, notably in configuration f-f (the SLM is at the object focal point of the optic) in order to retrieve in the medium the Fourier transform of the wavefront.

Beam 1 constitutes the reference. A moving mirror 7 generally makes it possible to modify the angle of the beam 1 in order to provide the multiplexing. In this case, an optic 8 is used in order to retain the overlapping of the beams 1 and 2 on the holographic medium 9 regardless of the angle imposed on the beam 1.

There are other solutions for changing angle, typical of which are the use of acoustic-optical modulators or the displacement of a lens.

As an example, the abovementioned document U.S. Pat. No. 6,700,686 describes in more detail an embodiment according to the concept of angle multiplexing.

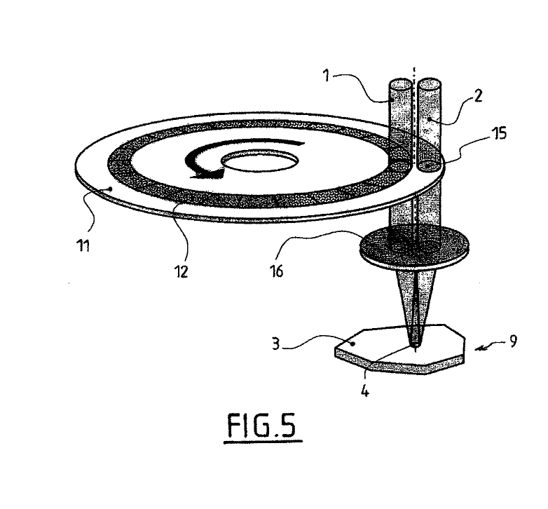

FIG. 3 describes the principle generally used in the prior art to perform phase coding of the reference beam 1. As in the preceding case, a laser beam is split into two sub-beams. The object beam is directed to an SLM 6 in order to code the wavefront.

Similarly, the reference beam 1 is also directed towards a second SLM 10 which can be identical or not to SLM 6. The objective of the modulator 10 is to modify the properties of the reference wavefront (the amplitude and/or phase; generally, the complex amplitude) sequentially and repeatably. Two focussing optics which can be combined into a single optic provide the focussing of the beams in the overlap zone.

The SLM 10 can be of the micro-mirror matrix type or can be a liquid crystal cell matrix.

Possibly, the coding of the reference beam and that of the object beam can be obtained from the same SLM as is demonstrated by Z. Karpati et al. in their publication “Comparison of coaxial holographic storage arrangements from the M number consumption point of view”, Jpn. J. Appl Phys 46 (2007) 3845-3849.

In both cases, the superimposition zone of the beams is positioned in a layer of photosensitive material 3 deposited on the storage medium 9. This medium is rotated in order to sequence the hologram writing zones.

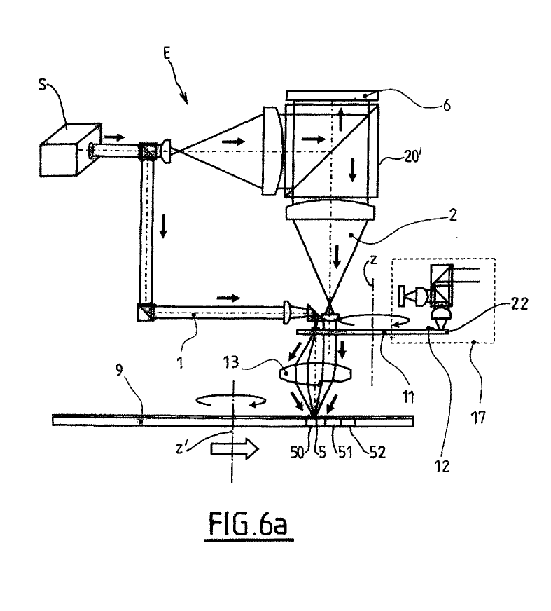

FIG. 4 gives the principle of angle coding according to the invention. In the case in point, the two beams 1 and 2 are placed side by side to prioritize co-linear exposure which at the present time seems to be the solution of choice for holographic storage.

The reference beam passes through the disc 11 in a structured zone 12. This zone contains a diffraction grating and has the effect of deflecting the incident beam by two angles α and ψ.

The object beam 2, the wavefront of which has previously been coded with the data to be stored, passes through the disc in a zone 12′ free of structuring and is not therefore subject to deflection.

An optic 13 is used to collect the beams 1 and 2 in order to make them converge towards the overlap zone in the photosensitive medium 3, on the hologram 4. To guarantee this good overlap, there can be various techniques. The figure represents that which uses a dual assembly 2f-2f and f-f. The structured zone 12 is located at a distance equal to two focal distances 2f of the optic 13, on the optical axis. All the beams obtained from this zone therefore converge in the image of the structured zone, at a distance 2f from the optic 13, on the optical axis.

Since the object beam is parallel to the optical axis of the system, if there is a desire to focus it on the hologram 3, a lens 14 must be used that has the same optical axis as the optic 13, but twice the focal length. This lens can be made as an insert of the preceding one, as shown in the figure, by moulding techniques.

Since the Fourier transform configuration is normally preferred, the SLM having coded the object wavefront is relayed by an optic that is not represented in the diagram so that its image is located in the zone 15, at the focal distance of the lens 14.

When the disc starts rotating, the beam 1 is subjected to a sequence of deflections by different angles α and ψ, but the overlapping of the object and reference beams remains on the hologram 4.

According to a preferred usage, the optic 13 can also comprise an opaque zone 13′ making it possible to filter the order 0 of the diffraction of the reference beam.

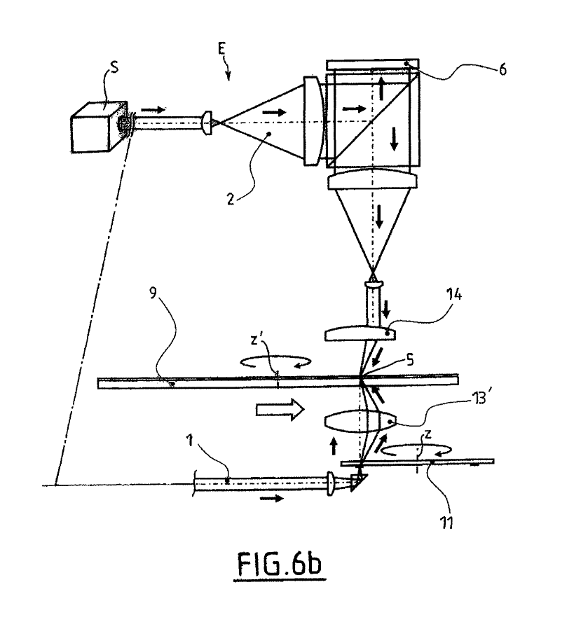

FIG. 5 gives the principle of phase coding according to the invention.

The beam 1 passes through a structured zone of the disc, on which are implemented diffractive optical elements 12, whereas the beam 2 passes through a free zone 12′ of the disc. This case is simpler than the preceding one because the optical elements 12 introduce a phase modulation which does not substantially modify the direction of propagation of the reference beam 1: the two beams 1 and 2 therefore remain parallel. The focussing optic 16 therefore has a single focal length, equal to the distance between the optic and the photo-sensitive medium. Since the Fourier transform configuration is generally preferred, the optical disc is also at focal distance from the optic 16 and, as in the preceding case, the object coding SLM is imaged by a relay optic that is not represented on the disc. Because of this, the hologram stores the interferences between the two Fourier transforms of the SLM and of the structured zone 12.

The spatial modulation of the reference beam can also be done by amplitude. More generally, the amplitude and the phase can both be modulated: the term complex amplitude modulation then applies.

According to a preferred embodiment, the coding disc 11 and the holographic medium 9 are made using similar materials and geometries (notably the thickness and the material of the substrate). Because of this, with thermal expansion phenomena, the coding variations of the reference beam follow the variations undergone by the hologram. Obviously, this is not possible when the modulation of the reference beam is produced by an SLM, as in the prior art.

A simple example is to consider an angle coding generated by a diffraction grating of pitch Λ_{grating}. The first order diffraction angle of the reference beam 1 is given simply by the following diffraction grating equation (assuming normal incidence on the grating):

$$α = arc sin ( \frac{λ}{{Λ}_{grating}} )$$

It is assumed that the object beam 2 is free of data. The hologram therefore consists of an interference figure, the pitch of which depends on the angle between the two beams 1 and 2. If the angle of incidence of the object beam on the medium is zero, the pitch of the interference figure is expressed by the equation:

$${Λ}_{holo} = \frac{λ}{2 sin ( \frac{α}{2} )}$$

If a change of temperature is reflected in an expansion by a factor ρ on the pitch of the interferences, the reciprocal angle α′ required to reconstruct the hologram becomes:

$${α}^{′} = 2 arcsin ( \frac{λ}{ρ {Λ}_{holo} \times 2} )$$

The diffraction grating for coding the reference beam has also been subjected to an expansion by a factor ρ, and the diffracted angle becomes α″:

$${α}^{′′} = arcsin ( \frac{λ}{ρ {Λ}_{grating}} )$$

For small angles it can therefore be seen that the effect of expansion on the grating offsets the angular variation induced by the expansion of the hologram:

α′=α″.

FIGS. 4 and 5 present the principle of writing the hologram; for reading, it is sufficient to consider these figures without the object beam which is reconstructed by the read beam below the holographic medium.

FIGS. 4 and 5 give the principle of writing with co-propagative colinear beams, that is beams that are propagated in the same direction and are incident to the holographic storage medium 9 on one and the same side of the latter. The principle of the invention also applies to the other writing/reading configurations such as the contra-propagative configuration, in which the beams 1 and 2 are propagated in opposite directions and are incident to the holographic storage medium 9 on two opposite sides of the latter.

Whether the multiplexing of the data is done in phase mode or angle mode, and the propagation geometry is co- or contra-propagative, it is advantageous for the hologram-recording beam to be pulsed, and more particularly for the laser to be off during the transition between two diffractive optical elements 12. This makes it possible to avoid the overlap between two reference patterns for a given object coding. When the useful beam touches the boundary separating two coding zones, the beam is cut and the object coding refreshed. When the useful beam has fully penetrated into the next zone, the laser is lit.

The duration for which the laser is lit depends mainly on the sensitivity of the holographic material. The more sensitive the material is, the shorter the pulse can be. The shorter the pulse is, the faster the holographic disc can rotate.

Exemplary embodiments which in no way limit the general nature of the invention are given hereinafter.

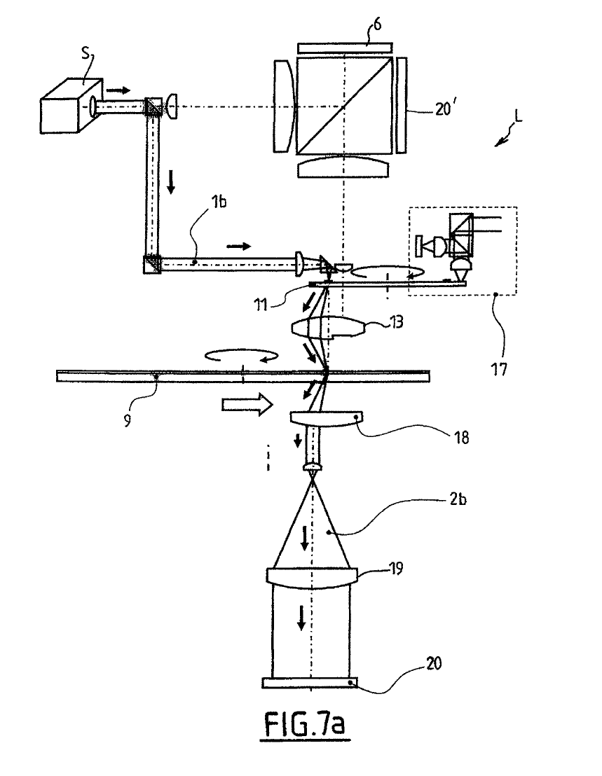

FIG. 6a represents a device E for storing data on a disc-shaped holographic storage medium 9 (holographic disc), operating according to the co-propagative method. In this device, the incident laser beam, generated by a source S such as a laser diode, is split into two sub-beams by a splitting cube. The object beam 2 is formatted by a telescope to adapt its size to that of the SLM 6. Once reflected by the spatial modulator, the object beam 2 is once again formatted by an objective which conjugates the SLM on the coding disc 11.

The reference beam 1 is also directed towards the holographic disc 9, and an optic is used to make the beam converge on the disc and adapt its size on the holographic medium 9. After passing through the coding disc, the reference beam is deflected in at least one of the two angular directions α and ψ (see FIG. 4).

The collection optic 13 makes it possible to converge the beams 1 and 2 within the overlap zone as is shown by FIG. 4.

The coding disc 11 is rotated rapidly about an axis Z by an actuator that is not represented, so as to pass over the path of the reference beam 1 the diffractive optical elements 12, which are arranged along a circular track, the centre of which coincides with said axis Z.

A structuring 22 present on the disc 11 enables a detection system 17 to synchronize the writing of the data in the holographic disc 9. This detection system is described hereinbelow. It is omitted from the following figures for the sake of simplicity.

The holographic disc 9 is rotated slowly about an axis Z′ by a first actuator (not represented) to enable multiplexing of the holograms within one and the same data storage area 5. The disc 9 thus rotates by an angular value corresponding to the pitch of these volumes for each coding sequence on the disc 11. In a preferred example, the disc 9 turns by this elementary angular value on each complete rotation of the disc 11.

The holographic disc 9 is also driven by a translation movement in a direction perpendicular to the axis of rotation Z′, by a second actuator (also not represented) so that the insulation of the data storage areas 5 covers all the available surface of the disc. More specifically, the storage areas 5 are arranged in a plurality of concentric, circular or spiral tracks 50, 51, 52, the centre of which coincides with said axis.

It will be noted that the holographic storage medium 9 is not necessarily in disc form, but that is just a preferred embodiment.

FIG. 6b shows an arrangement very similar to the preceding one in the case of contra-propagative exposure, in which beams 1 and 2 are incident on the holographic disc 9 on two opposite sides of the latter. Unlike the preceding case, these two beams are focussed on the data storage areas of the disc 9 by two separate optics 13′, 14.

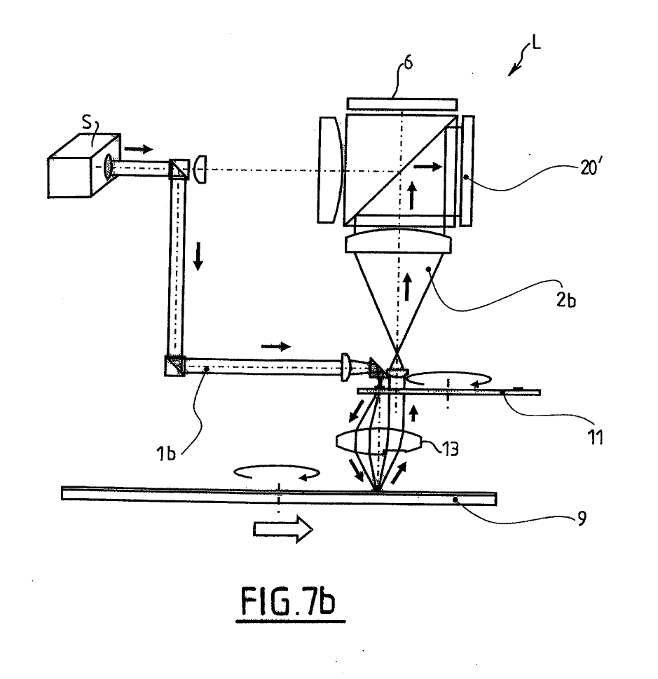

FIGS. 7a and 7b represent the devices L for reading data corresponding to the storage, or writing, devices of FIGS. 6a and 6b respectively.

In FIG. 7a, the read beam 1b is angle coded by the disc 11 as explained previously. The co-propagative writing case applies here, and the reconstituted object beam 2b is therefore propagated in the same direction as the read beam 1b. This beam 2b is collected by an optic 18, 19, then formatted to be conjugated on a matrix detector 20 which performs the reading of the data.

A synchronization system 17 is once again used to synchronize the matrix detector with the read coding.

FIG. 7a shows that the read head also comprises an SLM 6, which remains unused. In practice, in this way, one and the same optical head can be used equally to write and to read data.

FIG. 7b presents the case of the reading of a hologram written in contra-propagative mode. The reconstituted object beam 2b is therefore propagated in the reverse direction of the read beam 1b. The read arrangement is very similar to that of FIG. 6a.

A matrix detector 20′ is used to detect the data. The detector 20′ is also present in FIG. 7a: this writing/reading head therefore makes it possible to read holograms written in both co-propagative and contra-propagative modes.

The invention also provides a solution to the problem of replication of the holographic data storage media.

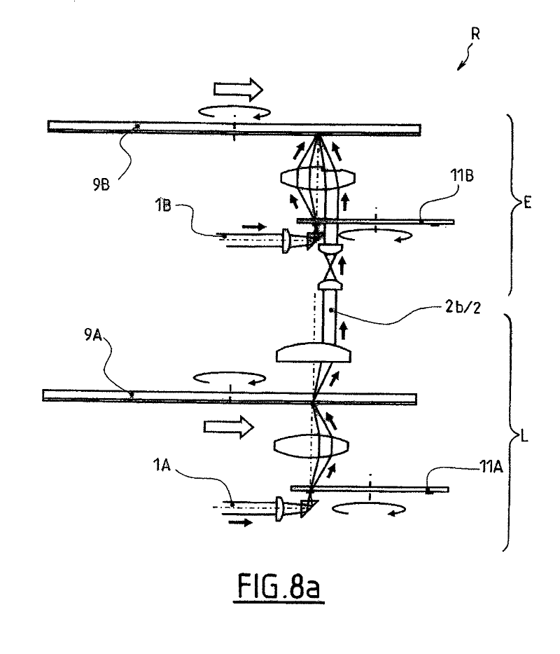

As explained above, the impossibility of using the pressing replication technique that has so contributed to the success of conventional optical discs prompts the consideration of replicating holographic discs by scanning, in which the holograms are replicated one by one. As FIGS. 8a and 8b show, a system of replication by scanning R mainly comprises a reading device L which reads the original holographic disc 9A, and a storage device E which writes the data read onto a blank medium 9B. Advantageously, the reading and storage devices L and E are optically coupled: this means that the reader L does not have the matrix detector 20, 20′ and that it supplies at its output a reconstituted light beam 2b/2 which serves as object beam, already modulated by the data to be written, to the writing device E. In turn, the latter does not require an SLM 6.

The speed with which the data is read and written is the main key to making this technology viable. It is therefore essential to be able to scan the holograms as quickly as possible. Now, the sequenced coding of the reference beam by a structured disc 11 indeed allows for a very fast scanning of the holographic disc 9.

If the coding disc 11 presents structuring zones 12 of size 630 μm arranged at a distance of 30 mm from the axis of rotation Z, there are 300 zones. If the disc rotates at 5000 revolutions per minute (rpm), the potential coding frequency is 25 kHz. A holographic disc with a holographic volume size of 600 Am contains approximately 23 000 available volumes. If each volume contains 300 holograms, it is therefore necessary, to read the disc entirely, to be able to have 7106 codings of the reference beam succeed each other.

At the coding frequency allowed by the rotation of the disc, it takes 4.6 minutes to replicate a disc. This is therefore far from the few seconds that pressing takes, but this time is more advantageous than in the case of a coding of the reference beam by an SLM. The coding frequency of the conventional SLMs is in practice a few hundred Hz and can rise to a few kHz in the case of the DLP products from Texas Instruments. In the case of the coding by revolving disc, the coding frequency will depend on the speed of rotation of the disc, and can therefore be very much higher.

To further reduce the production time, it may also be advantageous to expose several holograms at a time on different volumes at the same moment. The use of a revolving disc for the replication can therefore allow for a commercially advantageous solution.

FIG. 8a presents the case of the replication of a parent holographic disc 9A written in co-propagative mode to a replicated disc 9B also written in co-propagative mode. For this, two coding discs 11A and 11B are used. The two discs must be synchronized. The two beams 1A and 1B represented in the diagram originate from the same laser.

FIG. 8b shows an arrangement for replicating a parent holographic disc 9A written in contra-propagative mode to a replicated holographic disc 9B written in co-propagative mode. This arrangement has the advantage of being more compact than the preceding one and it is therefore possible to imagine combining the two discs 11A and 11B in a single piece in order to mechanically guarantee that their rotation will be synchronized.

Other configurations can, of course, be considered.

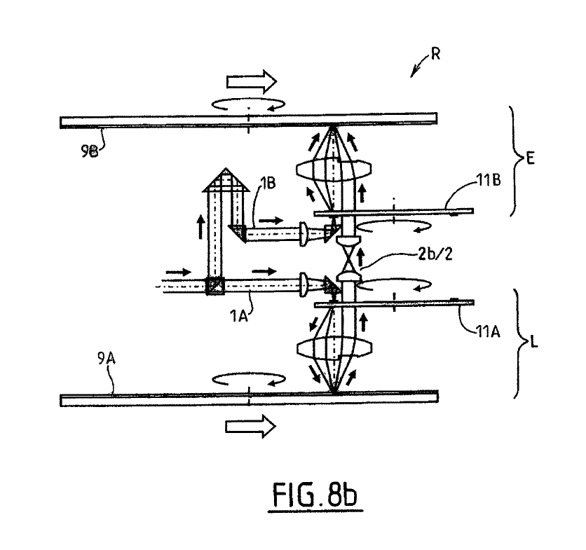

FIG. 9 presents the case of the writing of data on a phase-coded holographic disc. The arrangement is simpler than in the preceding case, in particular the optic for collecting the reference and object beams is unique. Only the case of co-propagative writing is therefore described.

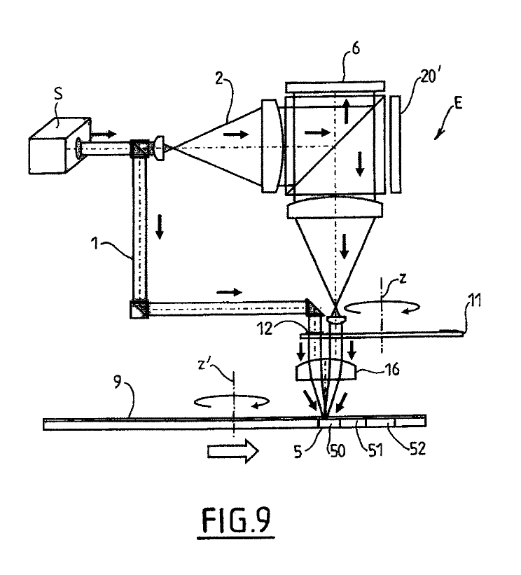

FIG. 10 describes the reading of a holographic disc written in contra-propagative mode in the case of phase coding. The co-propagative case is not described but can be deduced simply from the preceding figures.

The comparison of FIGS. 9 and 10 once again shows that one and the same optical head can be used both to write and to read the data.

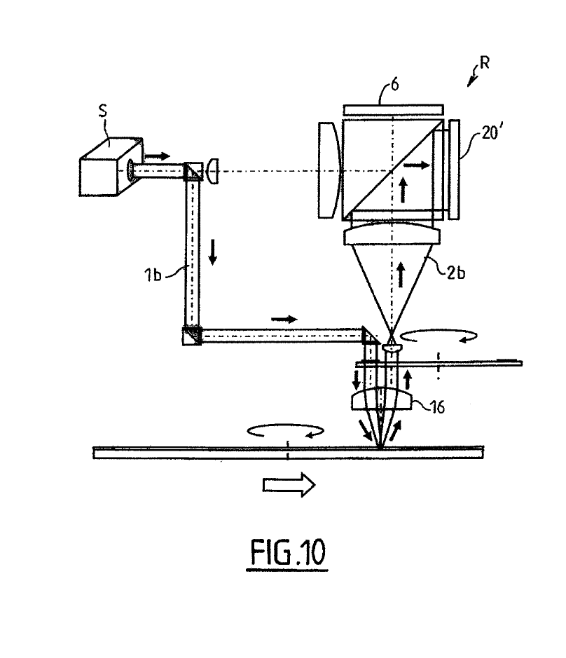

FIG. 11a describes the replication of a parent disc 9A written in contra-propagative mode in a replicated disc written in co-propagative mode in the case of phase coding.

FIG. 11b repeats the preceding figure in the case of multiple replication. As can be seen, the two reference laser beams are split into several sub-beams which each address a structured zone of the coding discs 11A and 11B. The holographic discs are moved horizontally during the writing over the distance separating the structured zones of the coding discs.

The discs 11A and 11B are in this case more complex and more voluminous than the preceding discs 11: in particular, they need to include a plurality of concentric circular tracks 120, 121, 122, the centre of which coincides with said axis, each of said tracks containing one and the same succession of diffractive optical elements 12. This does not however pose any problem because the replication equipment is generally technologically heavy. Its performance does not in effect relate to the compactness but to the bit rate. As an example, with 10 parallel replication heads, replication time for the preceding example changes to approximately 30 seconds.

By envisaging a reasonable distance between writing heads of 3 mm, 11 writing heads can be used to cover a total displacement of 36 mm (width of the writing zone on a disc of radius 60 mm).

Of course, multiple-head systems can be used each time a particularly rapid writing or reading of the data is desired, and not only in the context of replication.

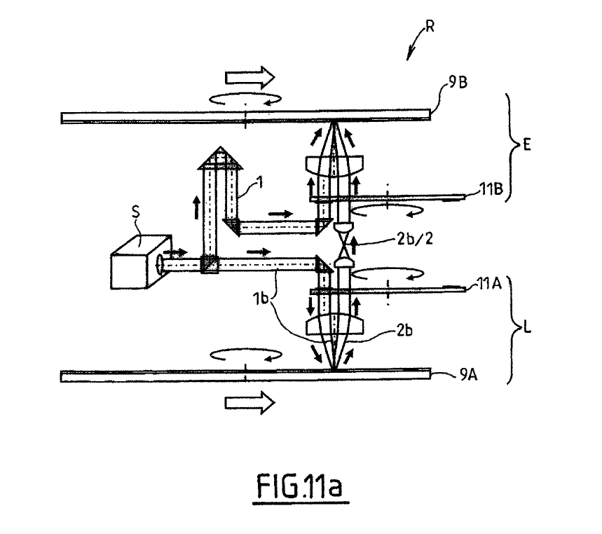

FIG. 12 describes the system for detecting marks on the disc 11. An optical source 21 is focussed on the disc 11 by a succession of reflecting cubes and lenses. The disc comprises a marking or structuring 22 which modifies the reflection of the beam on the surface of the disc. This reflected beam is detected by a photo-diode 23. The marking 22 makes it possible to identify the angular coordinate of the disc on its rotation (the arrow describes the movement of the pattern generated by the rotation of the disc). As an example, the marking 22 is an alternating pattern of reflecting and transparent bands, the period of which characterizes the position of the spot on the disc.

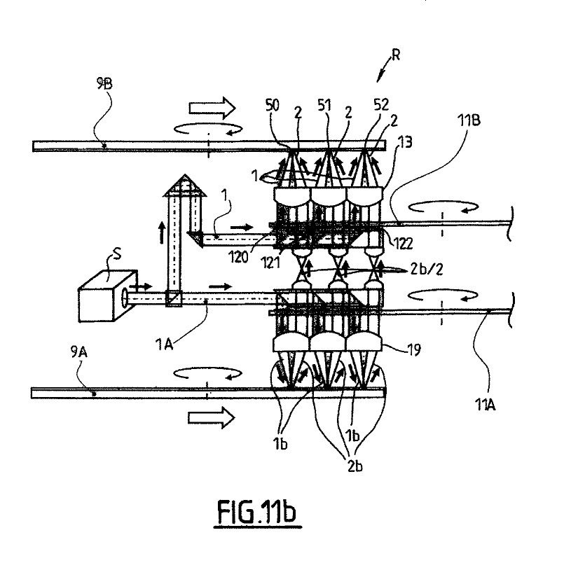

FIG. 13 describes a preferred embodiment of the inventive coding disc 11. It is based on a spiral movement of an exposure laser spot relative to a substrate.

The substrate 26, to be transformed into coding disc 11, revolves at the speed Vᵣₒₜ. The beam 24 is formatted by the writing head 25 which is driven by a translation movement at the speed Vₜᵣₐₙₛ. The direction of Vₜᵣₐₙₛ is radial, and perpendicular to the axis of rotation of Vᵣₒₜ. The laser spot exposure the substrate creates a modified zone in the sensitive layer 27, in the form of tracks separated by a pitch Λ. The value of the pitch sets the value of Vₜᵣₐₙₛ for a given rotation speed:

$${V}_{trans} = \frac{{V}_{rot}}{60} \times Λ$$

With Λ in μm, Vₜᵣₐₙₛ in μm/s and Vᵣₒₜ in rpm.

In the case of the spiral movement, the spot is displaced above the substrate with a speed called linear speed Vₗᵢₙ, an approximate expression of which is given by:

$${V}_{lin} = \frac{2 π \times R \cdot {10}^{- 3}}{60} {V}_{rot}$$

With R, the radius of the spot relative to the centre of rotation, in mm, and Vₗᵢₙ in m/s.

To retain a constant linear speed and therefore a uniform response from the material 27, the value of Vᵣₒₜ must change according to the position of the spot. The same applies with Vₜᵣₐₙₛ.

The speed of rotation must in particular increase when the spot approaches the centre of rotation. Since this speed is bounded by a value Vᵣₒₜₘₐₓ, retaining the pitch at a given linear speed imposes a minimum radius Rₘᵢₙ:

$${R}_{min} = \frac{60}{2 π} \frac{{V}_{lin}}{{V}_{rot \cdot max} \cdot {10}^{- 3}}$$

If Rₘₐₓ is used to denote the maximum radius of the spot, the exposure time T1 is deduced simply therefrom:

$$T 1 = \frac{1}{{V}_{lin}} \times \frac{π ( {R}_{max}^{2} - {R}_{min}^{2} )}{Λ}$$

The scanning of the writing spot is therefore done on the basis of a spiral. It is on this spiral that the sampling grid for the structuring patterns of the disc 11 is based.

On a reduced zone of the substrate 26, the spiral appears like a succession of parallel lines. It is therefore possible to approximate an orthogonal grid of pitch dr in the radial direction of the disc and dθ in the direction of the linear speed of displacement of the spot.

The writing resolution is given by the smallest possible values of dr and dθ.

The linear resolution dθ is set by the capacity of the laser to be modulated at high frequency. Let f1 be the maximum modulation frequency of the laser.

$$d θ = \frac{{V}_{lin}}{fl}$$

Exposure laser sources that can be modulated at 500 MHz are available on the market (see the product LDM A350 from Omicron Laserage Laserprodukte GmbH, www.lasersystem.de). When associated with a movement of linear speed 5 m/s, a resolution dθ=10 nm is obtained.

The resolution in the radial domain is given by the accuracy of the translation movement. Accuracies of the order of a few nanometres are currently available, notably through the use of precision optical rules. The radial resolution sets the pitch of the spiral and therefore the exposure time. It is therefore essential to use the highest possible value of dr in order to reduce this time.

This structuring technology therefore offers great accuracy by comparison to the conventional SLM technologies. Structuring a zone of side 600 μm on a grid of 100 nm allows a sampling in 6000×6000 elements. This is therefore well above the definition of the current SLMs which are of the order of 1500×1500 pixels.

Once the material 27 has been exposed, the disc fabrication process follows the conventional lithographic processing steps.

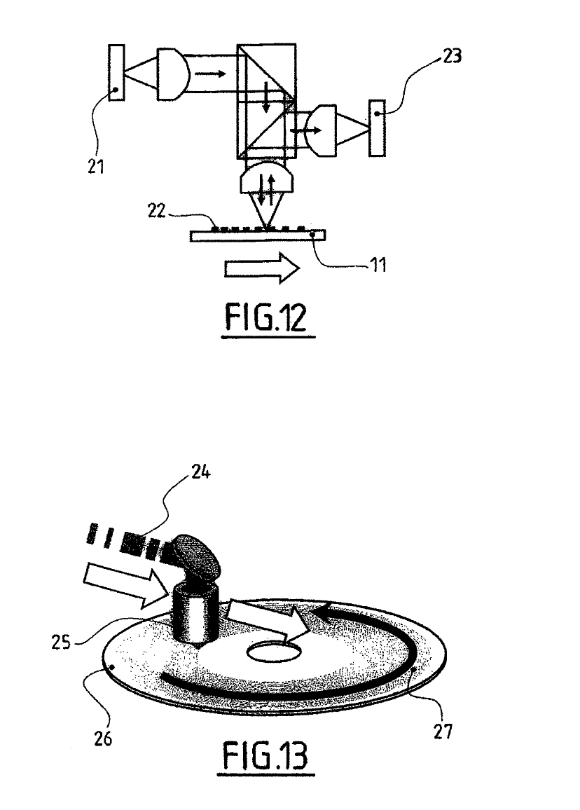

In the case of a resin, the latter is developed and then a thick layer of nickel 28 is grown by galvano-plasty. This layer is then removed then used to reproduce the original disc by injection moulding a plastic material, for example polycarbonate 29 (FIGS. 14a to 14d). FIG. 14e shows the result of the replication: a disc presenting a topographic structuring zone.

The coding discs 11 can thus be fabricated in large series by an extremely rapid and cost-effective moulding method. They are therefore, unlike SLMs, pivoting mirrors or acousto-optical modulator that they replace, low-cost devices, which have a negligible effect on the cost of the reading and writing devices incorporating them.

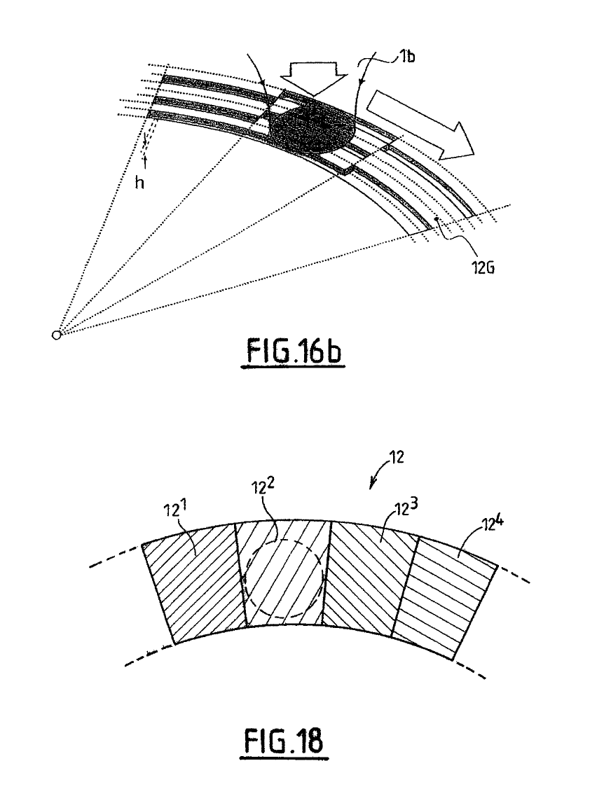

FIGS. 17a and 17b present another method of fabricating a coding disc 11. A layer of material 30 is used which has the property of being degraded when exposed by laser. The platinum oxide, PtOx, is an example of material which, under the thermal effect of a focussed laser beam is broken down into platinum and gaseous oxygen. Degassing causes the surface to deteriorate. The substrate can thus be used as an amplitude mask to produce diffraction gratings in order to implement an angle multiplexing of the data. The deteriorated surface zones 31 will in effect diffract the incident beam and produce an effect similar to an absorbent zone. It is therefore a (real) amplitude coding; however, in the prior art, it is usually referred to, even in this case, as “phase coding”.

The laser degradation of the surface generates, on the surface of the original disc (the “master”) a random relief having amplitude of a few tens of nanometres. Such an original disc can then be replicated very rapidly and in large series by the moulding method of FIGS. 14a-14e.

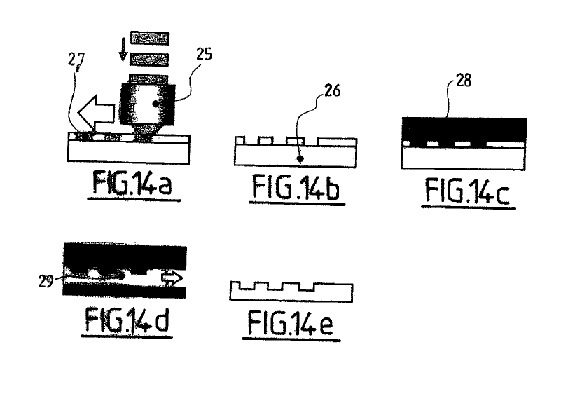

FIG. 15 presents an example of succession of diffractive optical elements 12A, 12B, 12C of diffraction grating type, to produce an angle multiplexing. The three successive zones are characterized notably by an grating pitch Λᵢ and by an angle ψᵢ relative to a reference axis. It can easily be seen that a laser beam scanned over these zones will be angularly coded at the output.

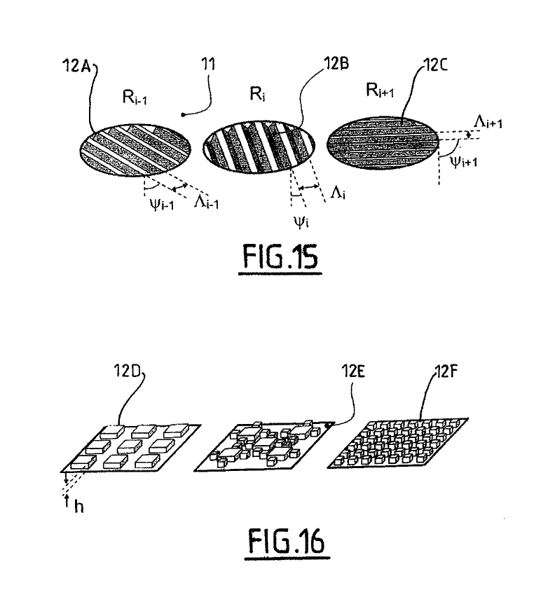

FIG. 16 presents an example of succession of diffractive optical elements 12D, 12E, 12F of phase coding type. The surface of the disc 11 comprises “topographic” zones making it possible to create a map of phase changes. The main parameter here is the height h of the relief. For an optimum phase shift, the change of phase must be close to π. The phase shift is given simply by:

$$δ ϕ = \frac{2 π}{λ} \times n \times h = ( 2 k + 1 ) π$$

hence:

$$h = ( 2 k + 1 ) \frac{λ}{2 n}$$

The minimum thickness for a material index of 1.5 at a wavelength of 405 nm is 135 nm. These values can be achieved with the etching and replication technologies. These techniques also offer a good accuracy on h.

The competing phase-shift technologies based on micro-mirrors normally involve great difficulties in producing changes of thickness that are as low and in guaranteeing a good accuracy on these values. The solution with replicated coding disc is therefore particularly attractive for multiplexing with phase coding.

If the material requires a relatively lengthy exposure time, the rotation of the disc can pose a problem, both in the case of angle coding and in that of phase and/or amplitude coding (“complex amplitude”). In this case, the displacement of the spot in a pattern structured in two dimensions, as described in FIG. 16, during the writing phase, must be negligible relative to the dimensions of the pattern. Otherwise, the interference figure may be scrambled. The same problem arises in the case of a one-dimensional pattern, but not limited to the radial direction of the disc (FIG. 15).

To avoid this phenomenon, it may be advantageous to use a one-dimensional coding pattern in the radial direction of the disc, an example of which is represented in FIG. 16b. This coding is one-dimensional, instead of being two-dimensional, but this does not significantly limit its coding potential. In effect, the number of codings remains limited for the holographic application (of the order of a few hundred), and a one-dimensional coding is more than sufficient.

A radial one-dimensional structuring can also be used for angle coding. In this case, the data is multiplexed only according to the angle α (see FIG. 4).

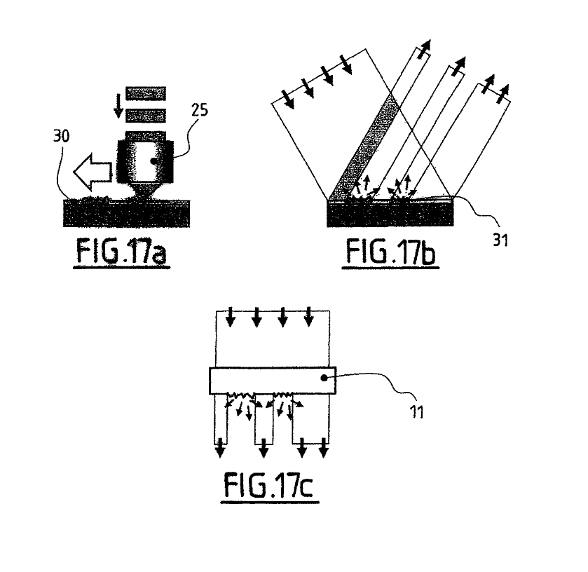

As FIG. 18 shows, in the case of angle coding, it is possible to multiplex the data according to the two angles α and ψ while avoiding the scrambling of the holograms by breaking down each diffractive optical element into sections 12¹, 12², 12³, 12⁴ arranged in succession in the angular direction of the disc and having approximately the same size as the writing or read beam, the orientation of the structuring of each section being chosen to offset the effect of the rotation of the disc. As an example, if we consider a diffractive element 12 having a radial dimension of 630 μm, positioned at 30 cm from the centre of the disc and scanned by a beam of 30 μm diameter, the angle variation induced by the rotation of the disc is 1.2°. If this element is segmented into 21 sections of 30 μm, the variation is only 3 minutes 25 seconds (or 0.057°). The coding beam can remain permanently lit, or be lit only in correspondence with the centre of the sections, which even further reduces the scrambling of the holograms.

The division into sections having variable orientations to offset the effect of the rotation of the disc can be applied also to phase coding (more generally, complex amplitude coding).

If the holographic material is very sensitive and can accept short writing pulses, then a two-dimensional coding scheme 12G, as represented in FIG. 16, is acceptable. If we take the example of a disc revolving at 1000 rpm, having 300 coding patterns positioned at a radius of 30 mm, the transition time from one zone to another is 200 μs. A source that can be modulated at 200 MHz supplies pulses of the order of 5 ns. During this pulse, the laser spot performs a displacement corresponding to 1/40 000th of the distance between two coding areas, or a negligible distance ratio.

1. Device for storing data on a holographic storage medium, comprising a plurality of data storage areas, said device comprising:
means for generating a first light beam called reference beam, and a second light beam called object beam, said beams being mutually coherent;
means for spatially modulating said object beam, the introduced modulation being representative of a block of data to be stored;
means for spatially modulating, in a predetermined way, said reference beam;
comprising an optical storage medium on which is implemented a succession of diffractive optical elements, each introducing a distinct modulation configuration and a first actuator for displacing said optical storage medium in order to sequentially bring said diffractive optical elements over a path of the reference beam;
an optical system for superimposing the spatially modulated object and reference beams, on a data storage area of said holographic storage medium, to store thereon a resulting interference figure;
a second actuator, synchronized with said means for spatially modulating the object and reference beams, to sequentially bring said data storage areas to the region where said beams are superimposed and interfere.
said means for spatially modulating said object and reference beams being synchronized to store a plurality of data blocks on said data storage area, each block being associated with a distinct modulation configuration of the reference beam, so as to multiplex said data blocks;
wherein said holographic storage medium is a disc that can be actuated rotationally about an axis and perpendicularly translationally about said axis, said data storage areas being arranged in a plurality of circular concentric or spiral tracks, a centre of which coincides with said axis.

2. Device according to claim 1, in which said optical storage medium, is a disc that can be actuated rotationally about an axis and comprising a plurality of concentric circular tracks, a centre of which coincides with said axis, each of said tracks containing one and the same succession of diffractive optical elements, the device also comprising:
means for generating and spatially modulating a plurality of object beams;
means for generating an equal number of reference beams, each of said reference beams being directed so as to cross one of the tracks of the optical storage medium to be in turn spatially modulated; and
a plurality of optical systems for superimposing each object beam on a reference beam on a data storage area belonging to a different track of said holographic storage medium, to store thereon the resulting interference figure;
so as to perform said data storage in parallel on several tracks of the holographic storage medium.

3. Device according to claim 1, in which each of the diffractive optical elements introducing a modulation of the reference beam is a diffraction grating for deflecting said beam by a different angle (α, ψ), so as to produce an angle multiplexing of said data blocks on said storage area.

4. Device according to claim 1, in which each of the diffractive optical elements introducing a modulation of the reference beam is adapted to introduce a modulation of a complex amplitude of said beam without substantially modifying its propagation direction, the modulation configurations introduced by said diffractive optical elements being substantially orthogonal to each other so as to produce a phase and/or amplitude multiplexing of said data blocks on said storage area.

5. Device according to claim 1, in which said object and reference beams are pulsed beams synchronized with the displacement of said optical storage medium so as to be off on transitions of said diffractive optical elements.

6. Device according to claim 1, in which said optical storage medium is a disc that can be actuated rotationally about an axis, said diffractive optical elements being arranged circularly around said axis.

7. Device according to claim 6, in which said optical storage medium comprises structuring arrangements for synchronizing the object beam's spatial modulation means with its rotation movement.

8. Device according to claim 6, in which the modulation configurations introduced by said diffractive optical elements are one-dimensional in the direction of rotation of the optical storage medium.

9. Device according to claim 6, in which each of said diffractive optical elements is subdivided into a plurality of successive sections, the orientation of which varies to offset the effect of rotation of said optical storage medium.

10. Device according to claim 1, in which said object and reference beams are incident to said holographic storage medium, on one and the same side of the latter.

11. Device according to claim 1, in which said object and reference beams are incident to said holographic storage medium on two opposite sides of the latter.

12. Device according to claim 1, in which said holographic storage medium and the optical storage medium carrying said diffractive optical elements present substantially identical thermal expansion coefficients.

13. Device according to claim 1, in which said optical storage medium carrying said diffractive optical elements is produced in plastic material by a moulding method.

14. Device for reading data recorded on a holographic storage medium, comprising a plurality of data storage areas, said device comprising:
means for generating a coherent light beam, called read beam;
means for spatially modulating, in a predetermined way, said read beam;
an optical system for directing the spatially modulated read beam to a data storage area of said holographic storage medium, and for collecting light diffracted by said area; and
a second actuator, synchronized with said means for spatially modulating the read beam, to sequentially bring said areas over a path of said beam;
said means for spatially modulating said read beam being adapted to read a plurality of data blocks stored on said data storage area, each block being read using a distinct modulation configuration of the read beam, so as to demultiplex said data blocks;
in which said means of spatially modulating said read beam comprises an optical storage medium on which is implemented a succession of diffractive optical elements, each introducing one said distinct modulation configuration, and a first actuator for displacing said optical storage medium in order to sequentially bring said diffractive optical elements over the path of the read beam;
wherein said holographic storage medium is a disc that can be actuated rotationally about an axis and translationally perpendicularly to said axis, said data storage areas being arranged in a plurality of circular concentric or spiral tracks, a centre of which coincides with said axis.

15. Device according to claim 14, in which said optical storage medium is a disc that can be actuated rotationally about an axis and comprising a plurality of concentric circular tracks, a centre of which coincides with said axis, each of said tracks containing one and the same succession of diffractive optical elements, the device also comprising:
means for generating a plurality of read beams, each of them being directed so as to cross one of the tracks of the optical storage medium to be spatially modulated; and
a plurality of optical systems, for directing each spatially modulated read beam to a data storage area belonging to a different track of said holographic storage medium, and for collecting light diffracted by each area, so as to perform said data read in parallel on several tracks of the holographic storage medium.

16. Device according to claim 14, in which each of the diffractive optical elements introducing a modulation of the read beam is a diffraction grating for deflecting said beam by a different angle, so as to produce a demultiplexing of data blocks angle multiplexed on said storage area.

17. Device according to claim 14, in which each of the diffractive optical elements introducing a modulation of the read beam is adapted to introduce a modulation of a complex amplitude of said beam without substantially modifying its direction of propagation, the modulation configurations introduced by said diffractive optical elements being substantially orthogonal to each other so as to demultiplex phase and/or amplitude multiplexed data blocks on said storage area.

18. Device according to claim 14, in which said optical storage medium is a disc that can be actuated rotationally about an axis, said diffractive optical elements being arranged circularly about said axis.

19. Device according to claim 18, in which the modulation configurations introduced by said diffractive optical elements are one-dimensional in the direction of rotation of the optical storage medium.

20. Device according to claim 18, in which each of said diffractive optical elements is subdivided into a plurality of successive sections, the orientation of which varies to offset the effect of rotation of said optical storage medium.

21. Device according to claim 14, in which said read beam is a pulsed beam synchronized with the displacement of said optical storage medium so as to be off on transitions of said diffractive optical elements.

22. Device according to claim 14, in which said read beam is diffracted forwards by said or each data storage area.

23. Device according to claim 14, in which said read beam is diffracted backwards by said or each data storage area.

24. Device according to claim 14, in which the holographic storage medium and the optical storage medium carrying said diffractive optical elements present substantially identical thermal expansion coefficients.

25. Device according to claim 14, in which said optical storage medium carrying said diffractive optical elements is produced in plastic material by a moulding method.

26. Device according to claim 14, also comprising at least one matrix detector for detecting light from said or each read beam diffracted by said or by each data storage area.

27. Device according to claim 26, in which the modulation configurations introduced by said diffractive optical elements are one-dimensional in the direction of rotation of the optical storage medium, and in which said optical storage medium comprises structuring arrangements for synchronizing the matrix detector with its rotation movement.

28. Device for replicating a first holographic storage medium on a second holographic medium, said replication device comprising a device for storing data on said second holographic medium, according to claim 1, in which the means of generating and spatially modulating the object beam or beams comprise a device for reading said first holographic storage medium comprising:
means for generating a coherent light beam, called read beam;
means for spatially modulating, in a predetermined way, said read beam;
an optical system for directing the spatially modulated read beam to a data storage area of said holographic storage medium, and for collecting light diffracted by said area; and
a second actuator, synchronized with said means for spatially modulating the read beam, to sequentially bring said areas over a path of said beam;
said means for spatially modulating said read beam being adapted to read a plurality of data blocks stored on said data storage area, each block being read using a distinct modulation configuration of the read beam, so as to demultiplex said data blocks;
in which said means of spatially modulating said read beam comprises an optical storage medium on which is implemented a succession of diffractive optical elements, each introducing one said distinct modulation configuration, and a first actuator for displacing said optical storage medium in order to sequentially bring said diffractive optical elements over the path of the read beam;
wherein said holographic storage medium is a disc that can be actuated rotationally about an axis and translationally perpendicularly to said axis, said data storage areas being arranged in a plurality of circular concentric or spiral tracks, a centre of which coincides with said axis.
